(19) United States
(12) Patent Application Publication
(10) Pub. No.: US 2018/0138966 A1
(43) Pub. Date: May 17, 2018

(54) VEHICLE-MOUNTED COMMUNICATION APPARATUS

(71) Applicants: AutoNetworks Technologies, Ltd., Yokkaichi (JP); Sumitomo Wiring Systems, Ltd., Yokkaichi (JP); SUMITOMO ELECTRIC INDUSTRIES, LTD., Osaka (JP)

(72) Inventor: Shinichi Ishiko, Yokkaichi (JP)

(21) Appl. No.: 15/801,538

(22) Filed: Nov. 2, 2017

(30) Foreign Application Priority Data
Nov. 16, 2016 (JP) 2016-223287

(51) Int. Cl. H04B 7/155; B60R 25/24

(52) U.S. Cl. CPC H04B 7/15507; H01Q 1/3275; B60R 25/245

(57) ABSTRACT

Provided is a vehicle-mounted communication apparatus. The vehicle-mounted communication apparatus includes a connection portion to which an external antenna is connected, and that performs wireless communication with a portable device via the external antenna connected to the connection portion, the vehicle-mounted communication apparatus including: a built-in antenna that is built into the apparatus; a detection unit that detects a connection state of the external antenna; and a switching portion that switches the antenna used for wireless communication with the portable device from the external antenna to the built-in antenna when disconnection of the external antenna is detected by the detection unit.

### CROSS-REFERENCE TO RELATED APPLICATIONS

This application claims priority of Japanese Patent Application No. JP2016-223287 filed Nov. 16, 2016.

### TECHNICAL FIELD

The present invention relates to a vehicle-mounted communication apparatus.

### BACKGROUND

A remote engine start system has been put into practical use as a system capable of remotely starting a vehicle engine without using a mechanical key. With the remote engine start system, when an operation portion (engine start button) provided on a portable device is operated by a passenger, a start signal for starting the engine is transmitted from the portable device to a vehicle-mounted communication apparatus, and control for starting the engine is performed by the vehicle-mounted communication apparatus that has received the start signal (see e.g., JP 2015-502467A).

By remotely starting the vehicle engine in advance using such a remote engine start system, it is possible to warm-up the vehicle, for example. Further, by operating an air conditioner as needed, the temperature inside the vehicle can be adjusted before the passenger gets into the vehicle.

With the remote engine start system, in order to increase the communication distance between the vehicle-mounted communication apparatus and the portable device so as to allow operations to be performed more remotely, a structure has been mainly used in which an independently provided antenna of the vehicle-mounted communication apparatus is installed at a position on the exterior of the vehicle (e.g., on the roof) where it is clearly visible, and the antenna and the vehicle-mounted communication apparatus are connected by a coaxial cable.

### SUMMARY

As described previously, with the structure in which the vehicle-mounted communication apparatus and the antenna are connected by a coaxial cable, there is the possibility that the coaxial cable will come loose from a coaxial connector owing to, for example, vibrations of the vehicle, or that a signal line of the coaxial cable may have broken as a result of the metal of the coaxial connector portion sliding and being bent.

When the engine is started using the remote engine start system, the vehicle door needs to be locked in advance for security reasons. Accordingly, the passenger operates a lock switch of the vehicle door to complete the locking of the vehicle door before operating the engine start switch of the portable device.

However, when the coaxial cable that connects the vehicle-mounted communication apparatus and the antenna has come loose or has broken owing to, for example, vibrations of the vehicle, the locking of the vehicle door cannot be completed even if the lock switch of the portable device is operated, thus making the passenger feel uneasy and also failing to ensure security.

It is an object of the present invention to provide a vehicle-mounted communication apparatus capable of ensuring a communication path with a portable device even if a coaxial cable that connects a vehicle-mounted communication apparatus to an antenna has come loose or has broken.

A vehicle-mounted communication apparatus according to an aspect of the present invention is a vehicle-mounted communication apparatus that includes a connection portion to which an external antenna is connected, and that performs wireless communication with a portable device via the external antenna connected to the connection portion, the vehicle-mounted communication apparatus including: a built-in antenna that is built into the apparatus; a detection unit that detects a connection state of the external antenna; and a switching portion that switches the antenna used for wireless communication with the portable device from the external antenna to the built-in antenna when disconnection of the external antenna is detected by the detection unit.

With the above-described configuration, it is possible to ensure a communication path with the portable device even if the coaxial cable that connects the vehicle-mounted communication apparatus and the antenna has come loose or has broken.

### BRIEF DESCRIPTION OF THE DRAWINGS

FIG. 1 is a diagram showing an exemplary configuration of a vehicle-mounted communication system according to an embodiment of the present invention;

FIG. 2 is a circuit diagram showing an example of a detection circuit; and

FIG. 3 is a diagram illustrating results of detection by the detection circuit.

### DETAILED DESCRIPTION OF PREFERRED EMBODIMENTS

Aspects of the present invention will be listed and described. At least some of the aspects described below may be combined freely.

A vehicle-mounted communication apparatus according to an aspect of the present application is a vehicle-mounted communication apparatus that includes a connection portion to which an external antenna is connected, and that performs wireless communication with a portable device via the external antenna connected to the connection portion, the vehicle-mounted communication apparatus including: a built-in antenna that is built into the apparatus; a detection unit that detects a connection state of the external antenna; and a switching portion that switches the antenna used for wireless communication with the portable device from the external antenna to the built-in antenna when disconnection of the external antenna is detected by the detection unit.

According to the above-described aspect, when disconnection of the external antenna is detected, the antenna used for wireless communication with the portable device is switched from the external antenna to the built-in antenna. Accordingly, even if the external antenna has been disconnected, it is possible to perform wireless communication by using the built-in antenna.

The vehicle-mounted communication apparatus according to an aspect of the present application includes an output unit that outputs a signal indicating that disconnection of the external antenna has been detected when disconnection of the external antenna is detected by the detection unit.

According to the above-described aspect, when disconnection of the external antenna is detected, a signal indicating that disconnection of the external antenna has been detected is output. Accordingly, it is possible to notify a passenger of the connection state of the external antenna using the signal.

In the vehicle-mounted communication apparatus according to an aspect of the present application, the detection unit includes a sending unit that sends a detection signal for detecting a connection state of the external antenna to the external antenna, the external antenna is connected to the connection portion by a cable including a transmission path for transmitting a detection signal sent from the sending unit to the external antenna, and a feedback path for feeding back the detection signal from the external antenna to the detection unit, and the detection unit detects the connection state of the external antenna according to the presence or absence of a detection signal input via the feedback path of the cable.

According to the above-described aspect, the detection signal sent from the detection unit of the vehicle-mounted communication apparatus is fed back from the external antenna by using a cable including a transmission path and a feedback path for a detection signal. Thus, according to the presence or absence of a detection signal to be fed back, a state in which the cable is connected can be detected so as to be distinguished from a state in which the cable has been disconnected or broken.

In the vehicle-mounted communication apparatus according to an aspect of the present application, the cable is a coaxial cable including an internal conductor that forms the transmission path, and an external conductor that forms the feedback path.

According to the above-described aspect, the detection signal can be transmitted using the internal conductor of the coaxial cable, and the detection signal can be fed back to the vehicle-mounted communication apparatus using the external conductor of the coaxial cable.

In the vehicle-mounted communication apparatus according to an aspect of the present application, the detection signal and a communication signal that is transmitted/received via the external antenna are transmitted sharing the transmission path.

According to the above-described aspect, a communication signal that is transmitted/received via the external antenna and the detection signal for detecting the connection state of the external antenna are transmitted sharing the transmission path. Accordingly, it is not necessary to separately provide a signal line in order to detect the connection state of the external antenna, making it possible to simplify the circuit configuration.

In the following, the present invention will be described in detail with reference to the drawings illustrating an embodiment thereof.

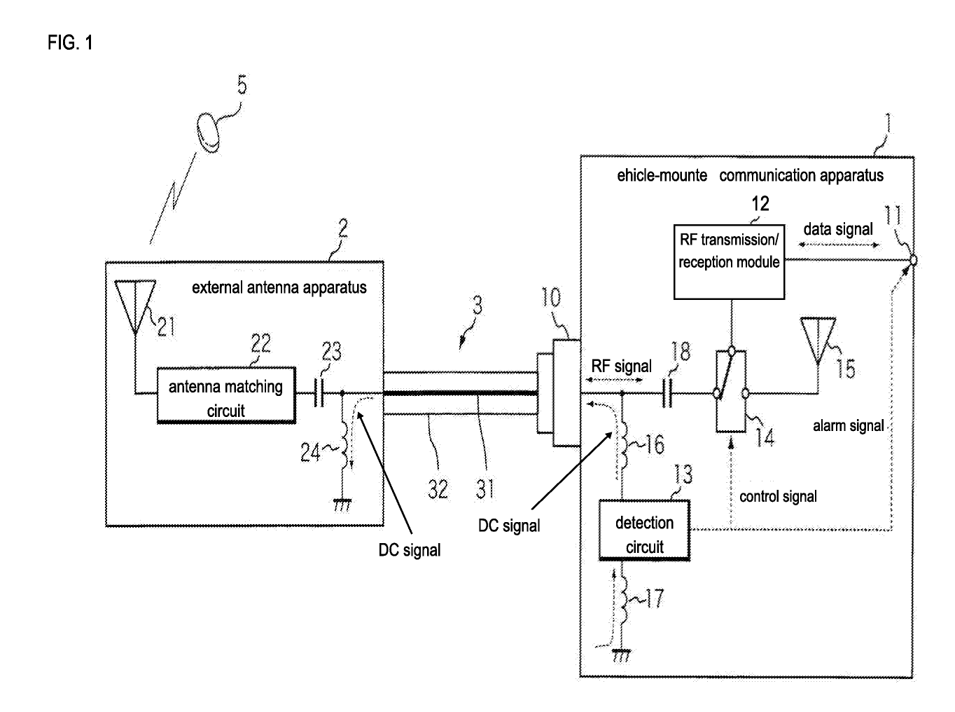

FIG. 1 is a diagram showing an exemplary configuration of a vehicle-mounted communication system according to the present embodiment. The vehicle-mounted communication system according to the present embodiment includes a vehicle-mounted communication apparatus 1 provided inside a vehicle, and an external antenna apparatus 2 that is installed at a location where it can be clearly seen, such as the vehicle roof, and is connected via a coaxial cable 3 to a coaxial connector 10 included in the vehicle-mounted communication apparatus 1. The vehicle-mounted communication system according to the present embodiment transmits and receives, for example, a radio signal (RF signal) in the 900 MHz band between the vehicle-mounted communication apparatus 1 and a portable device 5.

The vehicle-mounted communication apparatus 1 includes, for example, a data input/output port 11, an RF transmission/reception module 12, a detection circuit 13, an RF switch 14, and a built-in antenna 15.

The data input/output port 11 is connected to vehicle-mounted devices (not shown) that are provided inside the vehicle, such as various ECUs (Electronic Control Units) and a BCM (Body Control Module), and delivers/receives a data signal to and from the vehicle-mounted devices. For example, when a data signal output from the RF transmission/reception module 12 is input, the data input/output port 11 outputs the data signal to a vehicle-mounted device, and when a data signal output from the vehicle-mounted device is input, the data input/output port 11 outputs the data signal to the RF transmission/reception module 12.

The RF transmission/reception module 12 has the function of mutually converting a data signal that is input/output via the data input/output port 11 and an RF signal that is transmitted/received via the external antenna apparatus 2 (or the built-in antenna 15). The RF transmission/reception module 12 demodulates the RF signal received via the external antenna apparatus 2, and outputs a data signal resulting from the demodulation to the data input/output port 11. In addition, the RF transmission/reception module 12 modulates the data signal input via the data input/output port 11, and outputs an RF signal resulting from the modulation to the external antenna apparatus 2 via the coaxial cable 3, thus transmitting the generated RF signal from the external antenna apparatus 2 to the outside of the vehicle.

The detection circuit 13 is a detection circuit for detecting that the coaxial cable 3 has come loose from the coaxial connector 10, and that the coaxial cable 3 has broken. Although the details of the detection circuit 13 will be described later, the detection circuit 13 sends, via an RF choke coil 16, a DC signal to the external antenna apparatus 2 via an internal conductor 31 of the coaxial cable 3, and detects the presence or absence of a DC signal fed back via an external conductor 32 and an RF choke coil 17 of the coaxial cable 3, thus detecting that the coaxial cable 3 has come loose, or that the coaxial cable 3 has broken.

If it is detected that the coaxial cable 3 has come loose, or that the coaxial cable 3 has broken, the detection circuit 13 outputs a control signal to switch the RF switch 14, thus switching the antenna used by the vehicle-mounted communication apparatus 1 from the external antenna apparatus 2 to the built-in antenna 15.

If it is detected that the coaxial cable 3 has come loose or that the coaxial cable 3 has broken, the detection circuit 13 causes a breakage alarm signal to be output from the data input/output port 11, thus notifying, via the vehicle-mounted device, the passenger of the fact that the coaxial cable 3 has come loose or that the coaxial cable 3 has broken. At this time, it is possible to notify the passenger by outputting an alarm from the vehicle-mounted device, or to adopt a configuration in which a signal to cause the portable device 5 carried by the passenger to output an alarm is transmitted and the alarm is output from the portable device 5.

The RF switch 14 is a switch for switching the connection destination of the RF transmission/reception module 12 to the external antenna apparatus 2 or the built-in antenna 15 in accordance with a control signal from the detection circuit 13. In the present embodiment, the RF switch 14 is configured to connect the RF transmission/reception module 12 to the external antenna apparatus 2 when the coaxial cable 3 is connected to the connector 10 and the coaxial cable 3 has not broken, and the RF switch 14 is configured to connect the RF transmission/reception module 12 to the built-in antenna 15 when the coaxial cable 3 has come loose from the connector 10 or the coaxial cable 3 has broken.

When the built-in antenna 15 is connected to the RF transmission/reception module 12 by the RF switch 14, the built-in antenna 15 transmits the RF signal output from the RF transmission/reception module 12 to the outside of the vehicle, receives the RF signal transmitted from the portable device 5, and outputs the received RF signal to the RF transmission/reception module 12.

The built-in antenna 15 is an antenna for transmitting an RF signal in the 900 MHz band, for example, and can be reduced in size as compared with an antenna for transmitting signals in the 300 MHz band. A further size reduction can be achieved by loading a ferroelectric substance having a dielectric constant of 10 or more into the built-in antenna 15. In the present embodiment, line-of-sight communication is disabled in contrast to the external antenna apparatus 2. However, it is possible to ensure a communication distance of about 100 m as with RF antennas included in other vehicle-mounted devices.

Note that the vehicle-mounted communication apparatus 1 includes a DC cut capacitor 18 interposed between the detection circuit 13 and the RF switch 14. The DC cut capacitor 18 allows the passage of an RF signal exchanged between the RF transmission/reception module 12 and the external antenna apparatus 2 therethrough, and blocks DC signals sent from the detection circuit 13.

The external antenna apparatus 2 includes an antenna element 21, an antenna matching circuit 22, a DC cut capacitor 23, an RF choke coil 24, and so on. The external antenna apparatus 2 is connected to the coaxial connector 10 of the vehicle-mounted communication apparatus 1 by the coaxial cable 3 including the internal conductor 31 and the external conductor 32 disposed around the internal conductor 31.

The antenna element 21 transmits the RF signal input via the antenna matching circuit 22 to the outside of the vehicle, receives the RF signal transmitted from the portable device 5, and outputs the received RF signal to the vehicle-mounted communication apparatus 1 via the antenna matching circuit 22.

The antenna matching circuit 22 is a circuit for matching the output impedance on the transmission side with the antenna input impedance, and performs impedance conversion, for example, by adjusting the value of a variable reactance element such as a variable capacitance element or a variable inductance element.

The DC cut capacitor 23 is interposed between the antenna matching circuit 22 and an antenna input terminal of the external antenna apparatus 2. The DC cut capacitor 23 allows the RF signal exchanged between the antenna matching circuit 22 and the RF transmission/reception module 12 of the vehicle-mounted communication apparatus 1 to pass therethrough, and blocks the DC signal sent from the detection circuit 13 of the vehicle-mounted communication apparatus 1.

The RF choke coil 24 is disposed on a branch line branched from a signal line that connects the antenna input terminal and the DC cut capacitor 23. The other end of the branch line on which the RF choke coil 24 is disposed is connected to the external conductor 32 of the coaxial cable 3 via a common ground, and forms a feedback path for a DC signal that is a detection signal from the detection circuit 13.

The detection circuit 13 detects the connection state of the coaxial cable 3 (i.e., whether the coaxial cable 3 has come loose from the coaxial connector 10, or whether the coaxial cable 3 has broken) according to the presence or absence of a DC signal fed back via the external conductor 32 of the coaxial cable 3.

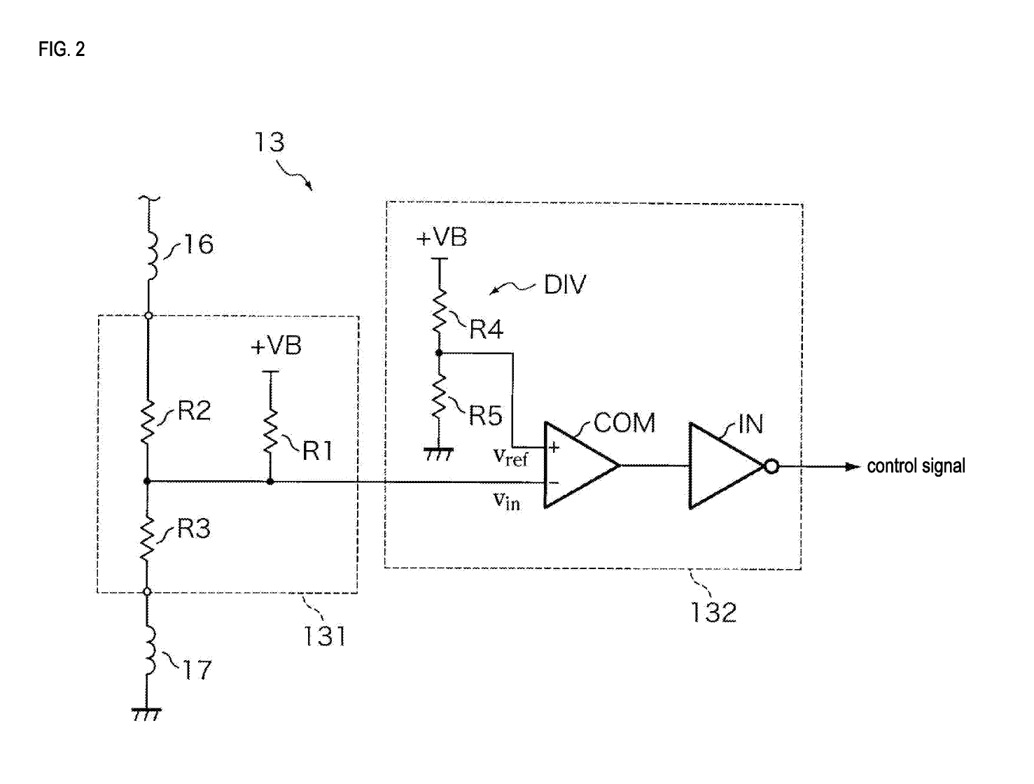

FIG. 2 is a circuit diagram showing an example of the detection circuit 13. The detection circuit 13 includes, for example, a DC bias circuit 131 and a DC detection circuit 132.

The DC bias circuit 131 includes a resistance R1 connected to a constant voltage VB, and resistances R2 and R3 that are provided between the two RF choke coils 16 and 17 and constitute a voltage dividing circuit. The DC bias circuit 131 superimposes the detection signal on a signal line that transmits the RF signal by outputting a bias current (e.g., a minute DC current of 10 μA or less) supplied via the constant voltage VB. Note that one end of the choke coil 17 is connected to the DC bias circuit 131, and the other end thereof is connected to a common ground shared by the external conductor 32 of the coaxial cable 3.

The DC detection circuit 132 detects the presence or absence of a detection signal fed back from the external antenna apparatus 2 via the coaxial cable 3. For example, the DC detection circuit 132 includes a voltage dividing circuit DIV that is composed of two resistances R4 and R5 and that divides the constant voltage VB, a comparator COM that compares the magnitudes of a reference voltage Vref and an input voltage Vin input via the DC bias circuit 131, taking the voltage divided by the voltage dividing circuit DIV as the reference voltage Vref, and an inverter IN that inverts the output of the comparator COM.

In the following, an operation of the detection circuit 13 will be described.

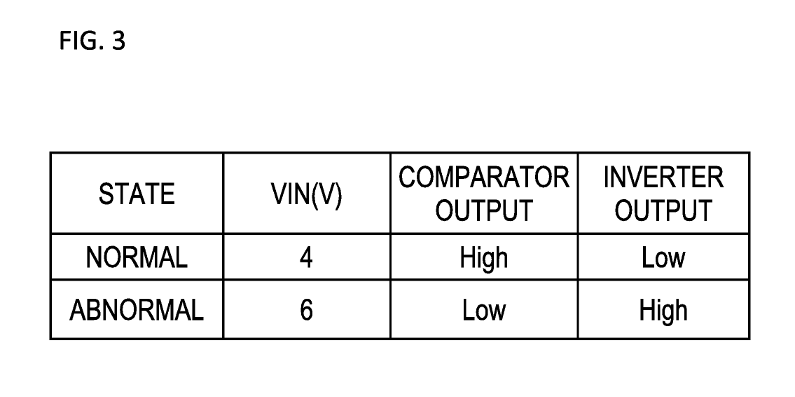

FIG. 3 is a diagram illustrating a result of detection by the detection circuit 13. In the present embodiment, for example, the constant voltage VB was 12 V, the resistance R4 was 70 kΩ, and the resistance R5 was 50 kΩ. At this time, the reference voltage Vref applied to one input terminal of the comparator COM is R5/(R4+R5)×VB=5 V.

When the connection state of the coaxial cable 3 is normal, or in other words, the coaxial cable 3 is connected to the connector 10 of the vehicle-mounted communication apparatus 1, and the coaxial cable 3 is not broken, the detection signal output from the DC bias circuit 131 is transmitted to the external antenna apparatus 2 via the internal conductor 31 of the coaxial cable 3. The detection signal transmitted by the internal conductor 31 of the coaxial cable 3 is fed back, via the RF choke coil 24, to the DC bias circuit 131 via the external conductor 32 of the coaxial cable 3 serving as a feedback path, and the RF choke coil 17.

At this time, the input voltage Vin applied to the other input terminal of the comparator COM is a divided voltage of the constant voltage VB provided by the combined parallel resistance of the resistances R2 and R3 and the resistance R1, so that Vin=(R2//R3)/(R1+R2//R3)×VB. Here, assuming that VB=12 V and R1=R2=R3=100 kΩ, R2//R3 (combined parallel resistance) is 50 kΩ, so that Vin=4 V.

As a result of comparing the reference voltage Vref (=5 V) with the input voltage Vin (=4 V), the comparator COM outputs a high-level signal. The inverter IN inverts the output of the comparator COM, and thus outputs a low-level signal.

On the other hand, when the connection state of the coaxial cable 3 is abnormal, or in other words, the coaxial cable 3 has come loose from the connector 10 of the vehicle-mounted communication apparatus 1, or when the coaxial cable 3 has broken, the minute DC current from the DC bias circuit 131 is superimposed on the signal line via the RF choke coil 16, and transmitted to the inlet of the coaxial connector 10. However, the minute DC current will not be superimposed on the internal conductor 31 of the coaxial cable 3, and a feedback path for the detection signal will not be formed. Accordingly, the detection signal will not be input to the DC bias circuit 131 via the external conductor 32 of the coaxial cable 3.

At this time, the input voltage applied to the other input terminal of the comparator COM is a divided voltage of the constant voltage VB provided by the resistance R3 and the resistance R1, so that Vin=R3/(R1+R3)×VB. Here, assuming that VB=12 V and R1=R3=100 kΩ, Vin=6 V.

As a result of comparing the reference voltage Vref (=5 V) with the input voltage Vin (=6 V), the comparator COM outputs a low-level signal. The inverter IN inverts the output of the comparator COM, and thus outputs a high-level signal.

In the present embodiment, the connection state of the RF switch 14 is switched in accordance with whether the control signal output from the detection circuit 13 (inverter IN) is a low-level signal or a high-level signal. Specifically, if a low-level control signal is input from the detection circuit 13, the RF switch 14 connects the RF transmission/reception module 12 to the external antenna apparatus 2. If a high-level control signal is input from the detection circuit 13, the RF switch 14 connects the RF transmission/reception module 12 to the built-in antenna 15.

With the above-described configuration, the RF switch 14 connects the RF transmission/reception module 12 to the external antenna apparatus 2 when the external antenna apparatus 2 is normally connected to the vehicle-mounted communication apparatus 1 by the coaxial cable 3. At this time, the vehicle-mounted communication apparatus 1 can perform wireless communication with the portable device 5 by using the external antenna apparatus 2, and thus can ensure a communication distance of 100 m or more.

On the other hand, when the coaxial cable 3 that connects the external antenna apparatus 2 and the vehicle-mounted communication apparatus 1 has come loose from the coaxial connector 10, or when the coaxial cable 3 has broken, the RF switch 14 connects the RF transmission/reception module 12 to the built-in antenna 15. At this time, the vehicle-mounted communication apparatus 1 has a communication distance of 100 m or less, but can wirelessly communicate with the portable device 5 by using the built-in antenna 15.

When wireless communication is performed between the vehicle-mounted communication apparatus 1 and the portable device 5 using the built-in antenna 15, the passenger cannot complete an operation such as locking a door from a location at a distance of more than 100 m. That is, even when the passenger has performed an operation such as locking a door by using the portable device 5, the passenger cannot be informed of completion of an operation such as locking a door from the vehicle-mounted communication apparatus 1. However, the passenger can complete an operation such as locking a door by approaching the vehicle and operating the portable device 5 from a location at a communication distance of 100 m or less, so the passenger can feel at ease. When the operation cannot be completed from a remote location, but can be completed when the passenger approaches the vehicle, the passenger can realize that the coaxial cable 3 may have come loose, or that the coaxial cable 3 may have broken.

In the present embodiment, for a backup use in case poor connection has occurred in the external antenna apparatus 2, communication means in the 300 MHz band, for example, does not need to be separately installed, and thus it is not necessary to take measures to simultaneously transmit/receive a radio signal in the 900 MHz band and a radio signal in the 300 MHz band. Accordingly, it is possible to avoid disadvantages such as a shortened battery life of the portable device 5, degraded door lock responsiveness, and troublesome door lock monitoring control.

It should be appreciated that the embodiment disclosed herein is to be construed in all respects as illustrative and not limiting. The scope of the present invention is defined by the claims, rather than the description of the embodiment above, and is intended to include all modifications which fall within the scope of the claims and the meaning and scope of equivalents thereof.

What is claimed is:

1. A vehicle-mounted communication apparatus that includes a connection portion to which an external antenna is connected, and that performs wireless communication with a portable device via the external antenna connected to the connection portion, the vehicle-mounted communication apparatus comprising:
a built-in antenna that is built into the apparatus;
a detection unit that detects a connection state of the external antenna; and
a switching portion that switches the antenna used for wireless communication with the portable device from the external antenna to the built-in antenna when disconnection of the external antenna is detected by the detection unit.

2. The vehicle-mounted communication apparatus according to claim 1, comprising
an output unit that outputs a signal indicating that disconnection of the external antenna has been detected when disconnection of the external antenna is detected by the detection unit.

3. The vehicle-mounted communication apparatus according to claim 1, wherein
the detection unit includes a sending unit that sends a detection signal for detecting a connection state of the external antenna to the external antenna,
the external antenna is connected to the connection portion by a cable including a transmission path for transmitting a detection signal sent from the sending unit to the external antenna, and a feedback path for feeding back the detection signal from the external antenna to the detection unit, and
the detection unit detects the connection state of the external antenna according to the presence or absence of a detection signal input via the feedback path of the cable.

4. The vehicle-mounted communication apparatus according to claim 3, wherein
the cable is a coaxial cable including an internal conductor that forms the transmission path, and an external conductor that forms the feedback path.

5. The vehicle-mounted communication apparatus according to claim 3, wherein
the detection signal and a communication signal that is transmitted/received via the external antenna are transmitted sharing the transmission path.
